(19) United States
(12) Patent Application Publication
(10) Pub. No.: US 2005/0197888 A1
(43) Pub. Date: Sep. 8, 2005

(54) Advertisement sign

(76) Inventor: Thomas Council, Byron, IL (US)

Correspondence Address: LEYDIG VOIT & MAYER, LTD.;(ROCKFORD OFFICE), TWO PRUDENTIAL PLAZA, SUITE 4900, 180 NORTH STESTON AVENUE, CHICAGO, IL, 60601-6780, US

(21) Appl. No.: 11/043,847

(22) Filed: Jan. 26, 2005

Related U.S. Application Data
(60) Provisional application No. 60/549,705, filed on Mar. 3, 2004.

(51) Int. Cl. G06F 17/60

(52) U.S. Cl. 705/10; 705/9; 705/22

(57) ABSTRACT

An information center that provides useful information to guests and visitors to help them enjoy their stay in an area is presented. The information includes a map of the area with points of interest, business cards with directions, pictures of area attractions, etc. The center has a local area map and a messaging system to provide messages for guests and/or employees. A plurality of business card holders, selectors, and information slots that provide information about businesses and attractions is on each side of the center. The holders hold business cards that provide driving directions to the business. The selectors are used to provide an indicator light on the map where the business/attraction is located so that the user can see where the business/attraction is located with respect to the hotel/business where the sign is located. Under the map is space for the establishment that is utilizing the information center.

### CROSS-REFERENCE TO RELATED PATENT APPLICATIONS

This patent application claims the benefit of U.S. Provisional Patent Application No. 60/549,705, filed Mar. 3, 2004.

### FIELD OF THE INVENTION

This invention relates generally to display signs and more particularly to hotel display signs having local information.

### BACKGROUND OF THE INVENTION

Many hotel guests are not familiar with the area where they are staying. As a result, the guests ask the front desk or the concierge (if the hotel has one) for information about the area. The information includes recommended places to eat, local attractions, local events, businesses, etc. and often directions to these places, attractions, events, etc.

Some hotels place information in guest rooms so that the guest can look up the information. This is sometimes helpful if the guest knows ahead of time the name or type of business. As a result, front desk personnel, concierges, valets, and the like are still often asked for recommendations and directions. The information provided is often the same as the recommendations are often for restaurants. What is needed is a method to display information of interest for guests.

The invention provides such an apparatus to display information of interest. These and other advantages of the invention, as well as additional inventive features, will be apparent from the description of the invention provided herein.

### BRIEF SUMMARY OF THE INVENTION

The invention provides an information center that can be displayed anywhere visitors congregate in an unfamiliar or strange location such as airports, hotels, convention centers, etc. The information center provides the hotel/business with the ability to provide useful information to guests and visitors to help them enjoy their stay in the area. This information may include a map of the local area with points of interest, direction cards with directions to a business/attraction, pictures of local area attractions, etc.

The information center has a top section, side sections, and a center section. The top section has a messaging system that provides the ability to provide messages for guests and/or employees. The side sections have a plurality of card holders, selectors (e.g., pushbuttons), and information slots that provide information about local businesses and attractions. The center section has a map of the local area and a section for information about the hotel/business.

The card holders are used to hold direction cards that can be used to provide driving directions to the business. Additionally, the direction card can have a coupon on the back of the card for use at the business. In one embodiment, the cards are held in place with a spring-loaded mechanism where a spring connected to block pushes the business cards so that a person does not have to dig around the holder for the business card.

The selectors are used to provide an indicator (e.g., a light) on the map where the business/attraction is located so that the user can see where the business/attraction is located with respect to the hotel/business where the sign is located. The selectors are typically pushbuttons so that the indicator is on only while the pushbutton is being selected. Behind the map is a plurality of lights that will illuminate when the selector is selected. Under the map is space for the establishment that is utilizing the information center.

Other aspects, objectives and advantages of the invention will become more apparent from the following detailed description when taken in conjunction with the accompanying drawings.

### BRIEF DESCRIPTION OF THE DRAWINGS

FIG. 1 is a perspective view of a hangable display in accordance with the teachings of the present invention;

FIG. 2 is an enlarged view of the display of FIG. 1 along line 2-2;

FIG. 3 is a view of a light array behind a portion of the display of FIG. 1;

FIG. 4a is a cross-sectional view of an embodiment of the display of FIG. 1 along line 4-4;

FIG. 4b is a cross-sectional view of an alternate embodiment of the display of FIG. 1 along line 4-4;

FIG. 5 is a block diagram illustrating how wiring is routed in the display of FIG. 1; and

FIG. 6 is a cross-sectional view illustrating an embodiment of how the display of FIG. 1 can be mounted to a wall.

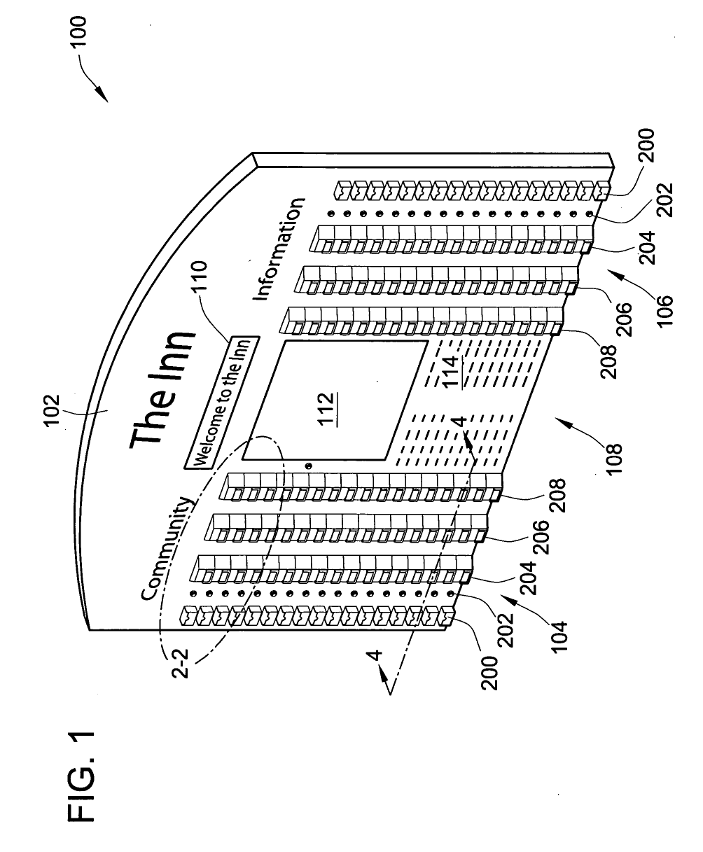

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

The invention provides an information center that can be displayed anywhere visitors congregate in an unfamiliar or strange location such as airports, hotels, convention centers, etc. The information center provides the hotel/business with the ability to provide useful information to guests and visitors to help them enjoy their stay in the area. This information may include a map of the local area with points of interest, cards with directions, pictures of local area attractions, etc.

Turning to the drawings, wherein like reference numerals refer to like elements, the information center 100 has a top section 102, side sections 104, 106, and center section 108. The top section 102 is generally used to provide the name of the hotel or business where the display 100 is located. An LED messaging system 110 (e.g., a LED display board, a LCD board, etc.) provides the ability to provide messages for guests and/or employees. The side sections 104, 106 provide information about local businesses and attractions. The center section 108 has a map 112 of the local area and a section for information about the hotel/business.

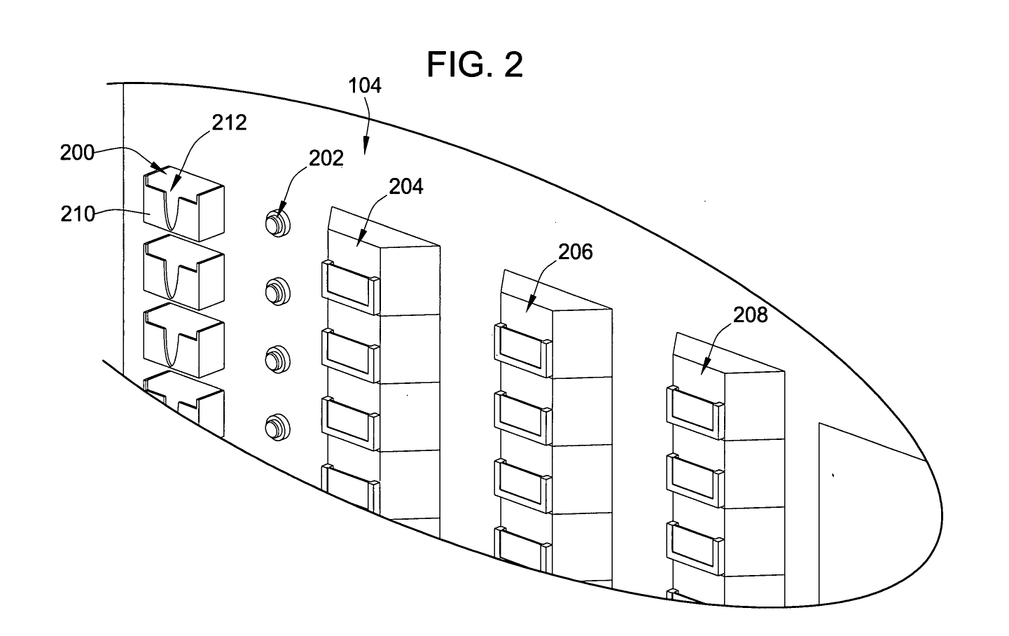

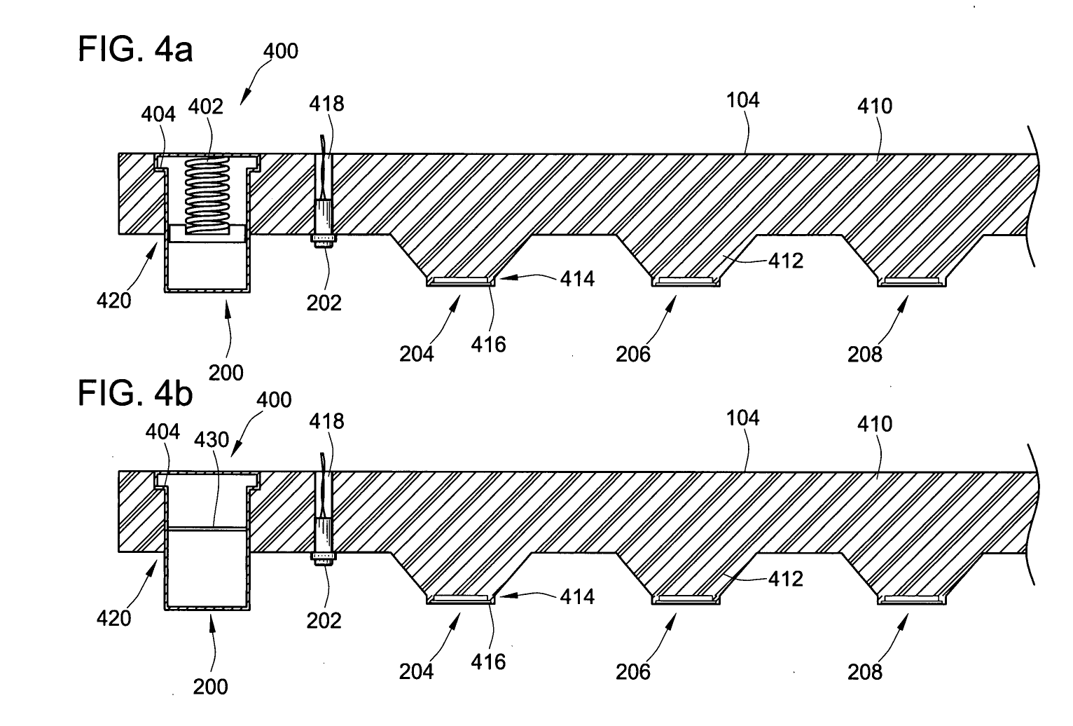

Turning now to FIG. 2, the side sections 104, 106 have a plurality of card holders 200, selectors 202 (e.g., pushbuttons), and information slots 204, 206, 208. The card holders 200 are used to hold cards, including business cards. For example, the card can be used to provide driving directions to the business. Additionally, the card can have a coupon on the back of the card for use at the business. In one embodiment, the cards are held in place with a mechanism 400 that is spring-loaded (see FIG. 4a) where a spring 402 connected to block 404 pushes the cards so that a person does not have to dig around the holder 200 for the card. The front 210 of the card holder has an arc shaped section 212 to allow a person to more easily select and remove a business card. In another embodiment, the cards are stacked and the mechanism 400 has a partition 430 that prevents the cards from moving too far from the front 210 of the card holder 200. In this embodiment, the arc shaped section 212 extends to the bottom of the card holder 200 as seen in FIG. 2.

The selectors 202 are used to provide an indicator (e.g., a light) on the map as described below so that the user can see where the business/attraction is located with respect to the hotel/business where the sign 100 is located. The selectors are typically pushbuttons so that the indicator is on only while the pushbutton is being selected.

The information slots 204, 206, 208 are used to provide information about the business/attraction. In one embodiment, slot 204 is used to provide a picture of the inside of a business to provide visual stimulation. This allows a visitor to know what the business looks like if the visitor decides to go to the business. Slot 206 is used to provide a picture of the outside of the business to provide visual stimulation. The picture provides a visitor with a view that could lead an undecided visitor to choose that business over another business. Slot 208 is used to indicate the type of business. For example, an information card about the business could be placed in the slot. Alternatively, a plate can be placed in the slot that displays the business name and other advertising by the business. It can slide in and out of place for easy removal. Note that the slots may be used for other items such as brochures, menus, etc. that the company can utilize. Other slots may be added to the information center 100.

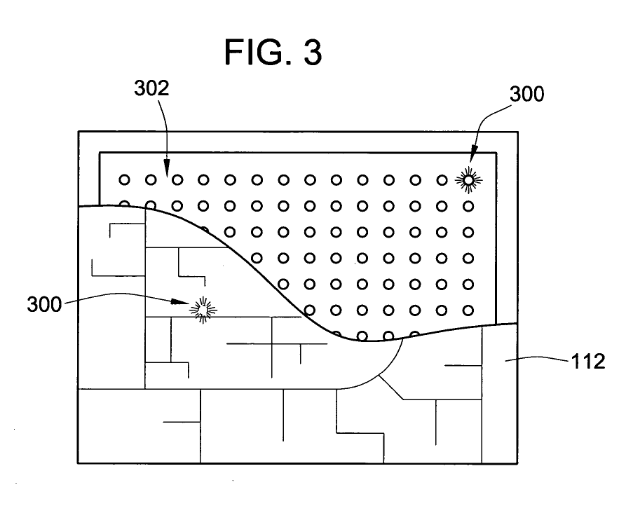

As previously indicated, the center section 108 has a map 112 of the local area and a section for information about the hotel/business. Behind the map is a plurality of small lights 300 (see FIG. 3) that will illuminate where area businesses of interest are located. The map portion is adapted to swing open to switch the location of lights (i.e., location of businesses) around within the array of light sockets 302. Alternatively, the array of light sockets 302 is accessible from the back and swings out or both the front and back are accessible. The lights illuminating the business locations easily switch (e.g., similar to a “Lite-Brite”) for different locations. In one embodiment, a light is placed in each socket and power is supplied selectively to the lights such that the correct light that is closest to the location of a business is illuminated when a selector 202 is selected for the business. Under the map is space 114 for the establishment that is utilizing the information center 100. For example, the space 114 can contain information about the business (e.g., pool hours, fitness hours, dinner hours, etc.), business logos and/or slogans, and the like.

The information center 100 should be light so that it can be hung easily. The information center may be made of sheet metal, wood, or other durable material. In one embodiment, the sections 102-106 are preferably made primarily from high density urethane foam and formed into the correct shape. For example, FIG. 4a shows section 104 of the center. The slots 204, 206, 208 are raised with respect to the base 410. The shape may be formed using a router. The base 410 in one embodiment is approximately four inches thick. The slots 204, 206, 208 are glued to the raised portion 412. Alternatively, the raised portion 412 has guides 414 formed in it for a cover 416 to be placed in the guides 414. The selector 202 is mounted in bore 418 and any wiring associated with the selector 202 is brought out through the back of bore 418. The card holders 200 and mechanism 400 with a spring-loaded mechanism 402 are mounted in bore 420 and anchored in the back of the base 410. In the alternative embodiment, a partition 430 is mounted in the card holder 200 to ensure that cards (e.g., directional cards) in the card holder 200 do not slide towards the back of the base 410 (See FIG. 4b).

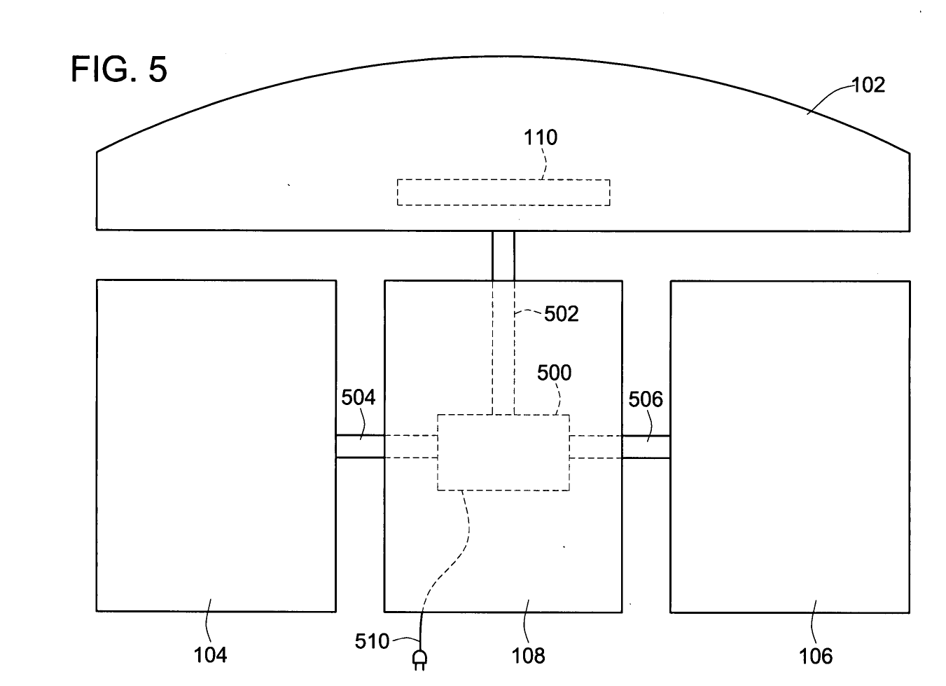

Turning now to FIG. 5, wiring for selectors 202 and messaging system 110 are routed in one embodiment from/to central panel 500 via paths 502, 504, 506. In one embodiment, the paths 504, 506 are the wires for selectors 202 bundled together and brought to the central panel 500 proximate the center of the respective sections 104, 106 via slots (not shown) in the section 104, 106. The connections for the array 302 also are routed to the central panel 500 for connection to power and the selectors 202. Power is supplied to the information center via plug 510. In one embodiment, the central panel 500 and array 302 are integrated. For example, the array 302 may have barrier strips, patch panels, terminal blocks, etc. for connecting wires from the selectors 202 to the array 302. A connection for programming the messaging system 110 is also provided at the central panel 500. Alternatively, a connection to the messaging system 110 is provided at an end of one of the sections 102-106 or the programming is done remotely.

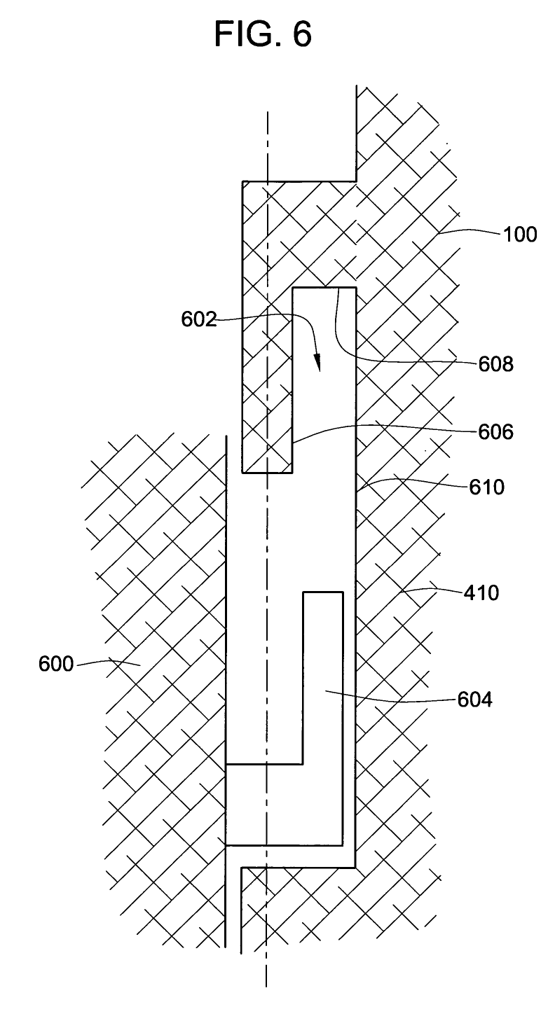

Turning now to FIG. 6, the information center 100 can be mounted to a wall 600 via a tongue and groove type of mechanism. In this embodiment, the information center 100 has a groove 602 in which a wall mount 604 slides into. Note that the information center 100 may be reinforced in the groove area 602 with durable material such that the areas 606-610 of the base 410 are strengthened to hold the information center 100 to the wall 600. This mounting arrangement provides a low mounting profile. Other mounting mechanisms may be used. For example, the information center 100 can be set up as a free standing display.

As can be seen from the foregoing, an information center that provides guests with information about local businesses and attractions has been described. In view of the many possible embodiments to which the principles of this invention may be applied, it should be recognized that the embodiment described herein with respect to the drawing figures is meant to be illustrative only and should not be taken as limiting the scope of invention. For example the information center could have a category plate that provides the information center maintainer (e.g., the establishment) the ability to further customize the information center by categorizing the businesses/attractions according to restaurant types, business types, etc.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1. An information center comprising:
a top portion;
a center portion integral to the top portion, the center portion having a map of an area;
a plurality of side portions integral to the center portion and the top portion, each side portion having a plurality of information slots, a plurality of card holders, and a plurality of selectors arranged in a plurality of rows.

2. The information center of claim 1 wherein the center portion further includes space for providing information.

3. The information center of claim 2 wherein the space is below the map and the information includes information about the establishment in which the information center is located.

4. The information center of claim 1 wherein the top portion has a messaging system.

5. The information center of claim 1 wherein the top portion further includes a name of the establishment in which the information center is located.

6. The information center of claim 1 wherein the map is one of transparent and translucent, the information center further comprising an array of sockets located behind the map adapted to receive at least one light to illuminate at least one location on the map.

7. The information center of claim 6 wherein at least one of the plurality of card holders is adapted to hold an information card about a business and wherein at least one of the plurality of selectors is located in a same row as the at least one of the plurality of card holders, the at least one of the plurality of selectors in communication with at least one light behind the map such that when the at least one of the plurality of selectors is selected, the light behind the map is energized at a location that indicates where the business is located.

8. The information center of claim 7 wherein each of the plurality of card holders is adapted to hold an information card about a business and has one of the plurality of selectors associated therewith and located proximate thereto, the one of the plurality of selectors in communication with at least one light behind the map such that when the one of the plurality of selectors is selected, the light behind the map is energized at a location that indicates where the business is located.

9. The information center of claim 8 wherein at least two of the plurality of information slots is located in the same row as the at least one of the plurality of card holders.

10. The information center of claim 9 wherein the plurality of information slots are adapted to hold images of the business.

11. The information center of claim 1 wherein at least one of the top portion, the center portion, or the plurality of side portions is made from high density urethane foam.

12. The information center of claim 11 wherein the top portion, the center portion, and the plurality of side portions are made from a single piece of high density urethane foam.

13. The information center of claim 1 further comprising a mounting mechanism for mounting the information center to a wall.

14. The information center of claim 13 wherein the mounting mechanism comprises a tongue and groove mechanism.

15. An information center comprising:
a top portion;
a center portion integral to the top portion, the center portion having a map of an area;
a plurality of side portions integral to the center portion and the top portion, each side portion having at least one information slot, at least one card holder, and at least one selector.

16. The information center of claim 15 further comprising a messaging system.

17. The information center of claim 15 wherein the map of the area is translucent, the information center further comprising an array of sockets located behind the map adapted to receive at least one light to illuminate at least one location on the map and wherein at least one of the plurality of card holders is adapted to hold an information card about a business and wherein at least one of the plurality of selectors is located in a same row as the at least one of the plurality of card holders, the at least one of the plurality of selectors in communication with at least one of the at least one light behind the map such that when the at least one of the plurality of selectors is selected, the light behind the map is energized at a location that indicates where the business is located.

18. The information center of claim 17 wherein each of the plurality of card holders is adapted to hold an information card about a business and has one of the plurality of selectors associated therewith and located proximate thereto.

19. The information center of claim 17 wherein at least two of the plurality of information slots is located in the same row as the at least one of the plurality of card holders.

20. The information center of claim 15 wherein the top portion, the center portion, and the plurality of side portions is made from high density urethane foam.
